(19) United States
(12) Patent Application Publication
(10) Pub. No.: US 2023/0076884 A1
(43) Pub. Date: Mar. 9, 2023

(54) STORAGE MEDIUM, OUTPUT METHOD, AND OUTPUT DEVICE

(71) Applicant: FUJITSU LIMITED, Kawasaki-shi (JP)

(72) Inventor: Masayuki Hiromoto, Kawasaki (JP)

(73) Assignee: FUJITSU LIMITED, Kawasaki-shi (JP)

(21) Appl. No.: 17/743,504

(22) Filed: May 13, 2022

(30) Foreign Application Priority Data
Sep. 9, 2021 (JP) 2021-147072

(51) Int. Cl. G06F 16/33

(52) U.S. Cl. CPC G06F 16/3344

(57) ABSTRACT

A non-transitory computer-readable storage medium storing an output program that causes at least one computer to execute a process, the process includes converting input data into a semantic representation; and outputting a validity score based on a matching degree between a first relationship between a noun and a verb in the semantic representation and a second relationship between the noun and the verb in a database.

### CROSS-REFERENCE TO RELATED APPLICATION

This application is based upon and claims the benefit of priority of the prior Japanese Patent Application No. 2021-147072, filed on Sep. 9, 2021, the entire contents of which are incorporated herein by reference.

### FIELD

The embodiments discussed herein are related to a storage medium, an output method, and an output device.

### BACKGROUND

In recent years, utilization of a neural network (NN) has become popular in fields such as syntactic parsing and image recognition. For example, with utilization of deep learning (DL), accuracy in the syntactic parsing and the image recognition has been greatly improved.

Most of the current machine learning trains using training data according to a task. Meanwhile, when a human carries out the syntactic parsing and the image recognition, a decision is made by utilizing “common sense” in addition to training for each task. Accordingly, it is considered that utilization of common sense is useful for the machine learning.

As basic technology for the existing common sense utilization, there is a technique that combines the NN and hyperdimensional computing (HDC), which is one of non-von Neumann computing technology focusing on information representation in the brain. This makes it possible to obtain and utilize common sense from a common sense database (DB) in the syntactic parsing and the image recognition, and to represent knowledge as a hyperdimensional vector (HV).

Japanese Laid-open Patent Publication No. 2004-054886 and Japanese Laid-open Patent Publication No. 2001-331318 are disclosed as related art.

### SUMMARY

According to an aspect of the embodiments, a non-transitory computer-readable storage medium storing an output program that causes at least one computer to execute a process, the process includes converting input data into a semantic representation; and outputting a validity score based on a matching degree between a first relationship between a noun and a verb in the semantic representation and a second relationship between the noun and the verb in a database.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for illustrating exemplary common sense inference according to an existing technique;

FIGS. 2A and 2B are diagrams for explaining an HV;

FIG. 3 is a diagram illustrating an exemplary configuration of an output device 10 according to a first embodiment;

FIG. 4 is a diagram illustrating an exemplary semantic graph and subgraph according to the first embodiment;

FIG. 5 is a diagram illustrating an exemplary scene graph according to the first embodiment;

FIG. 6 is a diagram illustrating an exemplary overall configuration of a validity score output process according to the first embodiment;

FIG. 7 is a diagram illustrating an example of the validity score output process according to the first embodiment;

FIG. 8 is a diagram illustrating another example of the validity score output process according to the first embodiment;

FIG. 9 is a diagram illustrating an exemplary output process in a case where a validity score is low according to the first embodiment;

FIG. 10 is a diagram illustrating an exemplary correction candidate output process according to the first embodiment;

FIG. 11 is a diagram illustrating an exemplary weighted validity score output process according to the first embodiment;

FIG. 12 is a flowchart illustrating an exemplary flow of the validity score output process according to the first embodiment; and

FIG. 13 is a diagram explaining an exemplary hardware configuration.

### DESCRIPTION OF EMBODIMENTS

In a case of using the HV, there are disadvantages in terms of use such as difficulty in interpreting common sense, and difficulty in linking with a common sense DB.

In one aspect, it is aimed to provide an output program, an output method, and an output device capable of making it easier to use a common sense utilization technique in machine learning.

In one aspect, it becomes possible to make it easier to use the common sense utilization technique in the machine learning.

Hereinafter, embodiments of an output program, an output method, and an output device will be described in detail with reference to the drawings. Note that the embodiments do not limit the present disclosure. Furthermore, the individual embodiments may be appropriately combined with each other within a range without inconsistency.

### First Embodiment

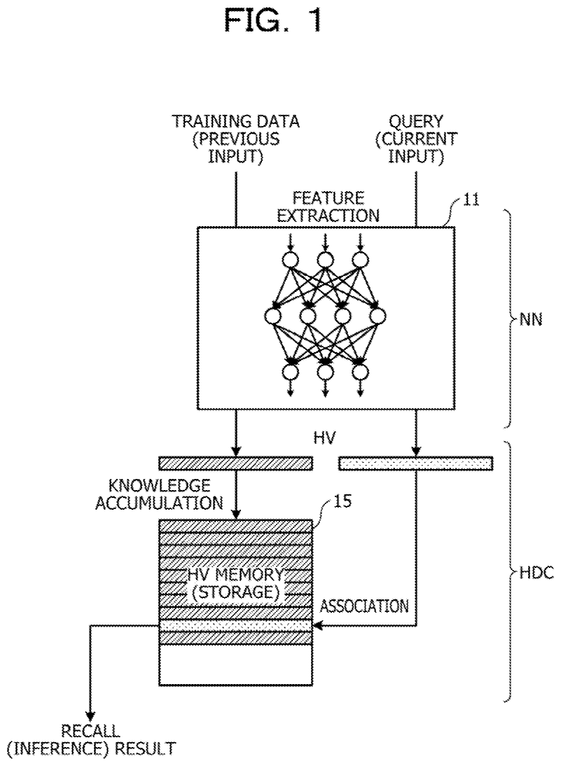

First, an existing technique of common sense inference to be executed by an information processing apparatus will be described with reference to FIG. 1. FIG. 1 is a diagram for illustrating exemplary common sense inference according to the existing technique. As illustrated in FIG. 1, in the exemplary common sense inference according to the existing technique, the information processing apparatus inputs training data to an NN 11 and extracts a feature of the training data in a learning phase of machine learning. Then, the information processing apparatus generates an HV on the basis of the extracted feature, associates the generated HV with a label of the training data, and accumulates it in an HV memory 15 as knowledge. The HV memory 15 is a content addressable memory (CAM), which recalls a label from the HV.

Then, in an inference phase of the machine learning, the information processing apparatus inputs a query to the NN11, and extracts a feature of the query. Then, the information processing apparatus generates an HV on the basis of the extracted feature, specifies a label recalled from the generated HV using the HV memory 15, and outputs the specified label as an inference result.

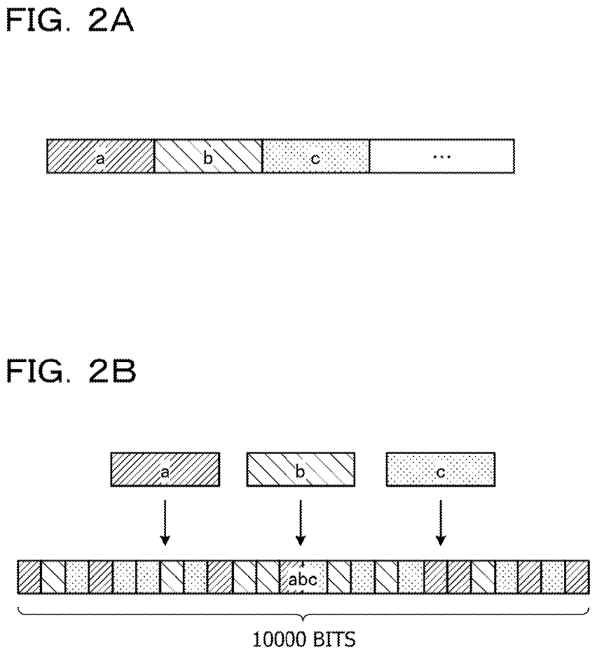

FIGS. 2A and 2B are diagrams for explaining the HV. The HV is data representation to be used in HDC. The HV represents data in a distributed manner with hyperdimensional vectors of 10,000 dimensions or more. The HV represents various types of data with vectors of the same bit length.

As illustrated in FIG. 2A, in normal data representation, each piece of data such as a, b, and c is collectively represented. On the other hand, according to the hyperdimensional vectors, data such as a, b, and c are represented in a distributed manner as illustrated in FIG. 2B. In the HDC, data may be manipulated by a simple operation such as addition or multiplication. Furthermore, in the HDC, it is possible to represent a relationship between pieces of data by addition or multiplication.

However, in a case of using the HV, there are disadvantages in terms of use such as difficulty in interpreting common sense, and difficulty in linking with a common sense DB. In view of the above, the present embodiment aims to provide an output program, an output method, and an output device capable of making it easier to use a common sense utilization technique in the machine learning.

[Functional Configuration of Output Device 10]

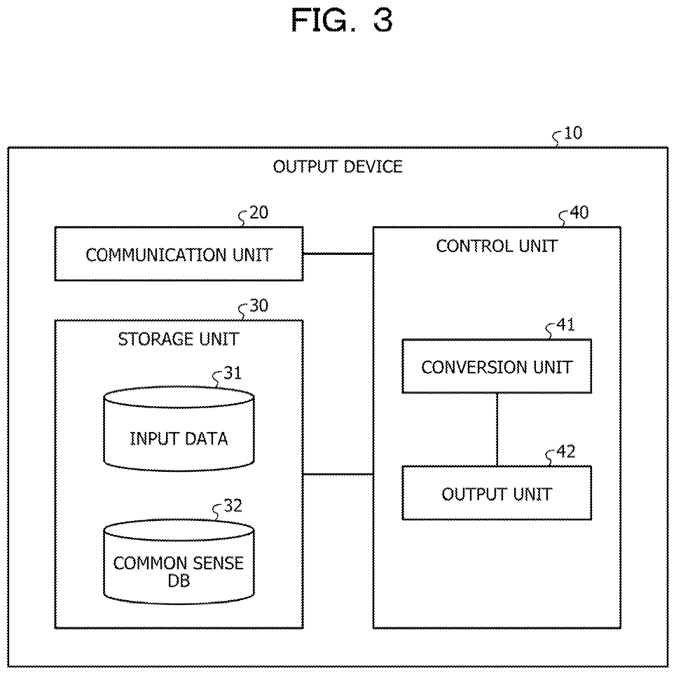

Next, a functional configuration of an output device 10, which is an execution subject of the present embodiment, will be described. FIG. 3 is a diagram illustrating an exemplary configuration of the output device 10 according to a first embodiment. As illustrated in FIG. 3, the output device 10 includes a communication unit 20, a storage unit 30, and a control unit 40.

The communication unit 20 is, for example, a processing unit that controls communication with another information processing apparatus to/from which various kinds of data, such as input data of images, texts, and the like, and determination results of validity scores are transmitted/received, and is, for example, a communication interface such as a network interface card.

The storage unit 30 is an exemplary storage device that stores various kinds of data and a program to be executed by the control unit 40, and is, for example, a memory, a hard disk, or the like. The storage unit 30 stores input data 31, a common sense DB 32, and the like.

The input data 31 stores data to be input to the output device 10 for the purpose of utilizing common sense. The data may be an image, or may be text. Furthermore, the data may be uploaded from the another information processing apparatus to the output device 10 via the communication unit 20, or may be read by the output device 10 via any computer-readable recording medium.

The common sense DB 32 stores, for example, a combination of a noun and a verb determined to be valid and a relationship type of the combination in association with each other. For example, the common sense DB 32 stores, for example, a combination of “human” (noun) and “draw” (verb), and “capable of”, which is a relationship type of the combination, in association with each other. Furthermore, as another example, the common sense DB 32 stores a combination of “draw” (verb) and “picture” (noun), and “related to”, which is a relationship type of the combination, in association with each other. Note that the nouns and verbs, and the relationship types are not limited to the examples described above.

Note that the information described above stored in the storage unit 30 is merely an example, and the storage unit 30 may store various types of information other than the information described above.

The control unit 40 is a processing unit that controls the entire output device 10, and is, for example, a processor or the like. The control unit 40 includes a conversion unit 41 and an output unit 42. Note that each processing unit is an exemplary electronic circuit included in a processor or an exemplary process to be executed by the processor.

The conversion unit 41 analyzes the input image or text, and converts it into a semantic representation. For conversion of text into a semantic representation, the conversion unit 41 converts a text meaning into a semantic representation expressed by a directed acyclic graph using an abstract meaning representation (AMR) parser of an existing technique, for example.

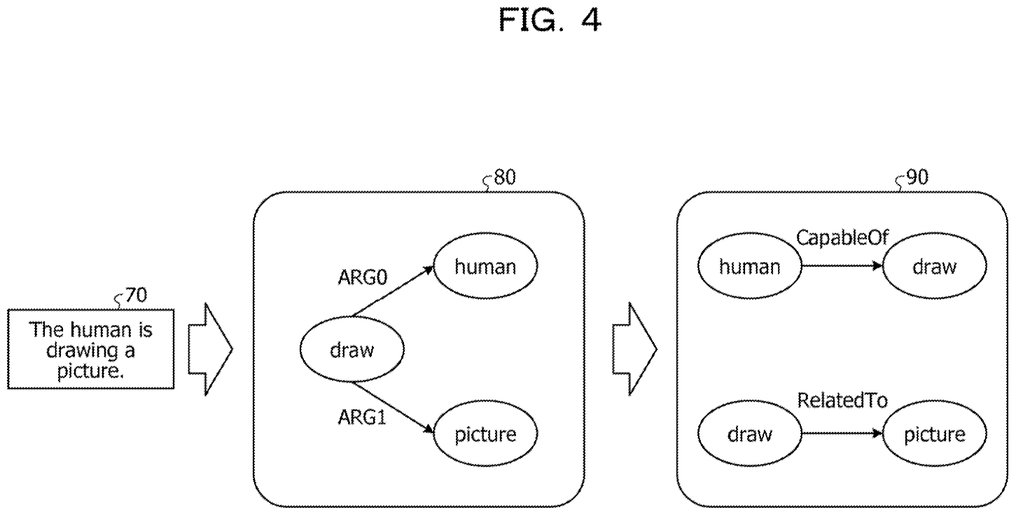

FIG. 4 is a diagram illustrating an exemplary semantic graph and subgraph according to the first embodiment. As illustrated in FIG. 4, the conversion unit 41 interprets a meaning of text data 70 in natural language using the AMR parser, and generates a semantic graph 80. Furthermore, the conversion unit 41 extracts a subgraph 90 from the semantic graph 80. The subgraph 90 may be formally represented as a set having a triplet in a form of (“subject”, “predicate”, “object”) as an element, for example. Here, “subject” represents an object to be a subject, “object” represents an object to be an object, and “predicate” represents a relationship between those objects. For example, the example of FIG. 4 includes triplets such as (“human”, “capable of”, “draw”) and (“draw”, “related to”, “picture”). Such an expression format has an advantage that it is easy to handle in the subsequent computer processing as compared with the representation as the HV.

Meanwhile, for conversion of an image into a semantic representation, the conversion unit 41 generates a scene graph that describes a relationship between objects contained in the image using a scene graph generator of an existing technique, and converts the image into a semantic representation on the basis of the scene graph, for example.

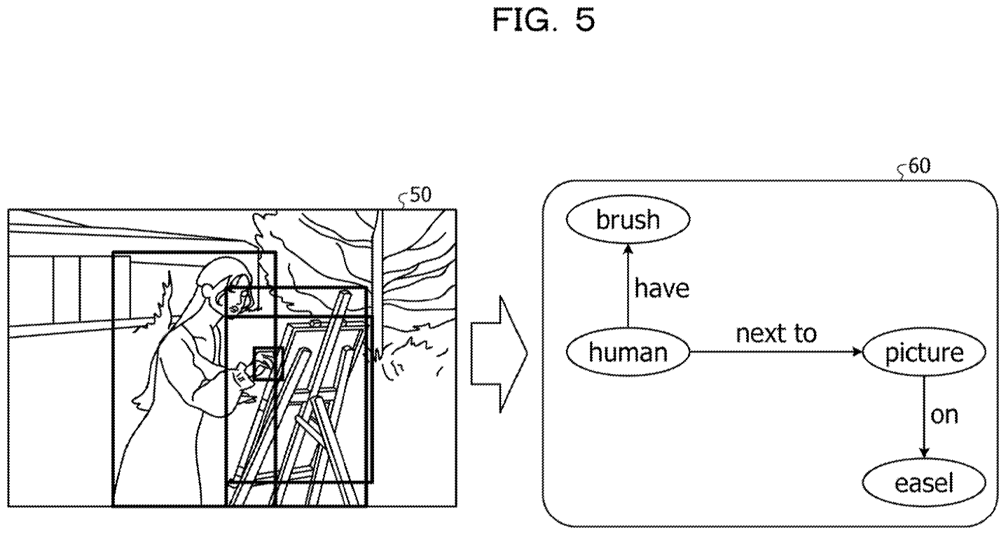

FIG. 5 is a diagram illustrating an exemplary scene graph according to the first embodiment. As illustrated in FIG. 5, using the scene graph generator, the conversion unit 41 interprets meanings of objects contained in a captured image 50, performs extraction from the captured image 50 with the objects as nodes and relationships between the objects as directed edges, and generates a scene graph 60. In a similar manner to the case of the text data 70 described with reference to FIG. 4, in the case of the scene graph 60 as well, the conversion unit 41 is enabled to convert the scene graph 60 into triplet representation in the form of (“subject”, “predicate”, “object”), which is, it is enabled to extract a subgraph from the scene graph 60. Note that each node of the semantic representation for the image is not necessarily a word, and may be represented in a vector format including image features and the like.

The output unit 42 outputs a validity score on the basis of a matching degree between a first relationship between the noun and the verb in the semantic representation and a second relationship between the noun and the verb in a database stored in advance. For example, the output unit 42 searches the common sense DB 32 for the combination of individual nodes in the subgraph converted from the image or text data by the conversion unit 41, counts the number of matches, and outputs it as a validity score. Note that the combination of individual nodes stored in the common sense DB 32 may be weighted, and the validity score may be calculated on the basis of the weighting.

Furthermore, the validity score is an exemplary index indicating that the combination of nodes is valid, which is a commonsensical combination, and may be used at a time of determining validity of a sentence, for example. However, with the validity score used as an index indicating specificity of a sentence, for example, it becomes possible to select, from collected ideas and the like, sentences with untrammeled and unconventional contents, novel contents, conspicuous opinions, and the like.

Furthermore, in a case where the validity score is lower than a predetermined threshold value, the output unit 42 searches the common sense DB 32 for a second relationship similar to the first relationship in the semantic representation that has not matched, and outputs it as a correction candidate.

[Function Details]

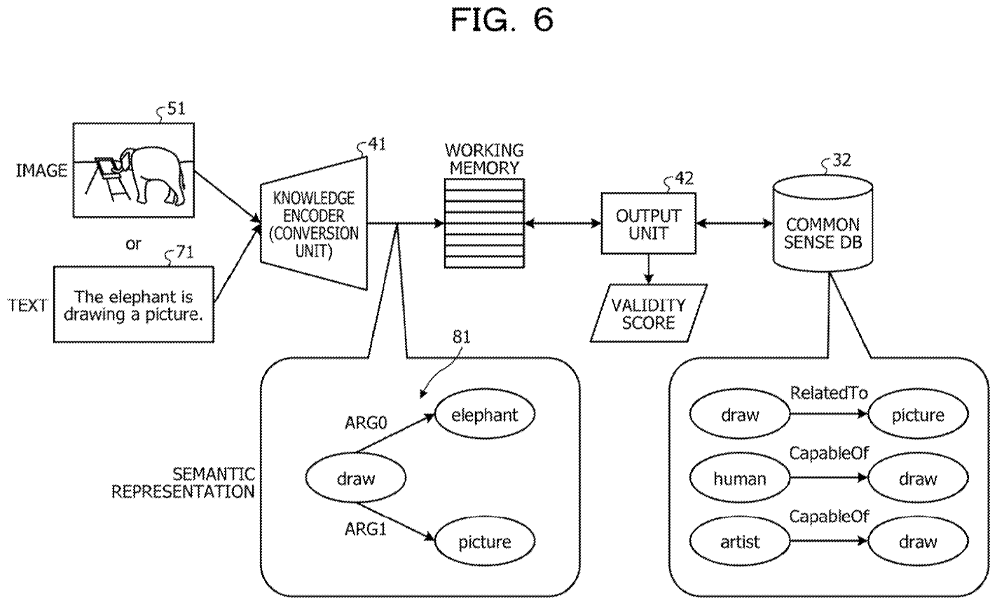

The output process of the validity score, which makes it easier to use the common sense utilization technique in the machine learning, will be described in more detail with reference to FIGS. 6 to 11. FIG. 6 is a diagram illustrating an exemplary overall configuration of the validity score output process according to the first embodiment. The execution subject of the validity score output process illustrated in FIG. 6 is the output device 10.

As illustrated in FIG. 6, first, the conversion unit 41 that is a knowledge encoder or includes a knowledge encoder converts a captured image 51 or text data 71 input to the output device 10 via another information processing apparatus or any computer-readable recording medium into a semantic graph 81, which is a semantic representation. Note that the knowledge encoder may be, for example, a scene graph generator in a case of processing the captured image 51, or may be an AMR parser in a case of processing the text data 71.

Then, the output unit 42 searches the common sense DB 32 on the basis of the subgraph extracted from the semantic graph 81, and outputs a validity score on the basis of a matching degree between the relationship between the noun and the verb in the subgraph and the relationship between the noun and the verb in the common sense DB 32.

The output process of the validity score will be described with a specific example. While the following output process of the validity score will be explained using a case where text data is input as an example, in a case where image data is input as well, the knowledge encoder to be used at the time of semantic graph generation is different but the subsequent process is similar to that in the case where the text data is input.

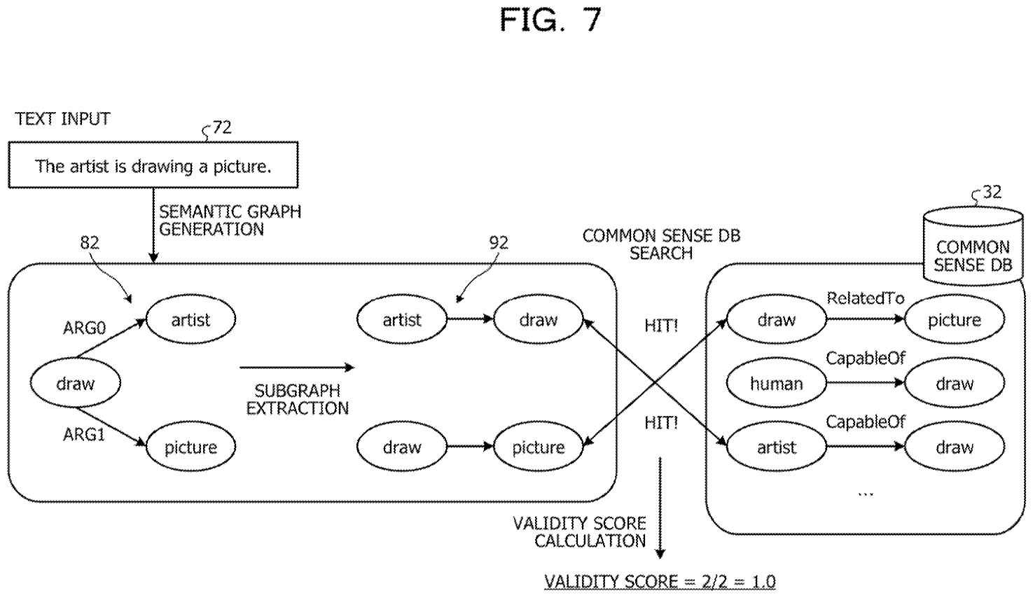

FIG. 7 is a diagram illustrating an example of the validity score output process according to the first embodiment. As illustrated in FIG. 7, the output device 10 converts input text data 72 into a semantic representation using a knowledge encoder, and generates a semantic graph 82. Next, the output device 10 extracts a subgraph 92 from the semantic graph 82.

Then, the output device 10 searches the common sense DB 32 for each combination of a noun and a verb included in the extracted subgraph 92, and calculates a validity score on the basis of a matching degree of the combination. In the example of FIG. 7, both of two combinations of “artist” and “draw” and “draw” and “picture” included in the subgraph 92 match the data in the common sense DB 32, and thus the validity score is the number of combination matches 2/the total number of combinations 2=1.0. Note that, while the matching combination of the noun and the verb is searched from the common sense DB 32 in the example of FIG. 7, the searching may be carried out by including, in addition to the combination, a relationship type thereof.

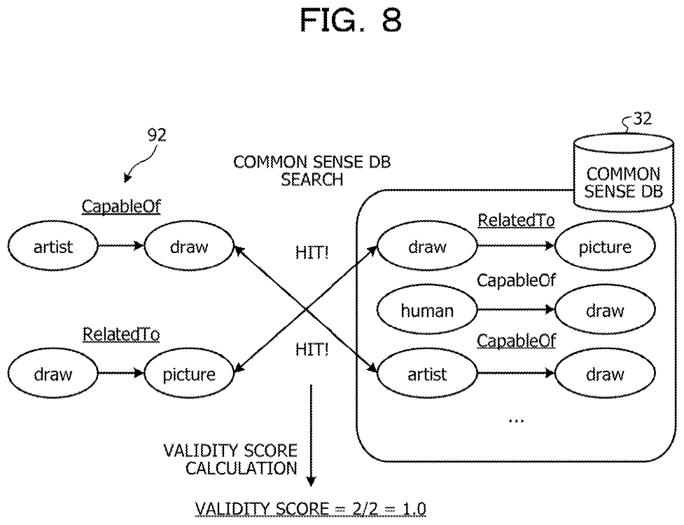

FIG. 8 is a diagram illustrating another example of the validity score output process according to the first embodiment. As illustrated in FIG. 8, the output device 10 searches the common sense DB 32 by including, in addition to the combination of the noun and the verb included in the extracted subgraph 92, a relationship type thereof, and calculates a validity score on the basis of a matching degree between the combination and the relationship type thereof. In the example of FIG. 8, both of two combinations of “artist” and “draw” and “draw” and “picture” included in the subgraph 92 match the data in the common sense DB 32 including the individual relationship types of “capable of” and “related to”. Accordingly, the validity score is the number of combination matches including the relationship type 2/the total number of combinations 2=1.0.

The exemplary case where the validity score is high, which is a case where all combinations included in the subgraph 92 match the data in the common sense DB 32, has been described with reference to FIGS. 7 and 8, and next, an exemplary case where the validity score is low will be described.

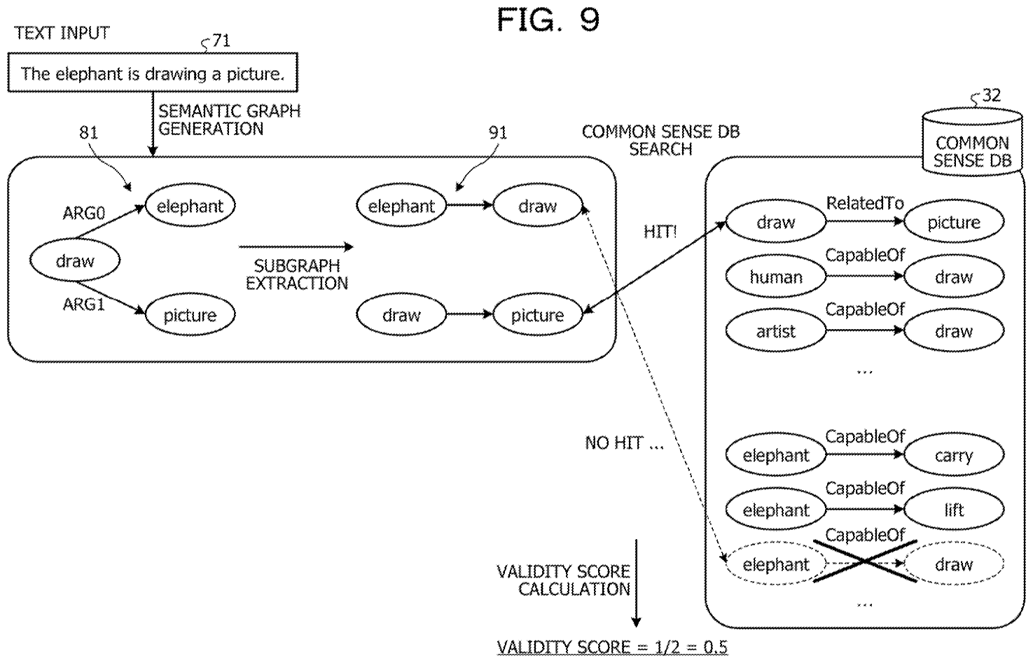

FIG. 9 is a diagram illustrating an exemplary output process in a case where the validity score is low according to the first embodiment. As illustrated in FIG. 9, the output device 10 converts the input text data 71 into a semantic representation using a knowledge encoder, and generates the semantic graph 81. Next, the output device 10 extracts a subgraph 91 from the semantic graph 81.

Then, the output device 10 searches the common sense DB 32 for each combination of a noun and a verb included in the extracted subgraph 91, and calculates a validity score on the basis of a matching degree of the combination. The example of FIG. 9 indicates that, while the combination of “draw” and “picture” included in the subgraph 91 matches the data in the common sense DB 32, the combination of “elephant” and “draw” does not match. In this case, the validity score is the number of combination matches 1/the total number of combinations 2=0.5. Note that, while the matching combination of the noun and the verb is searched from the common sense DB 32 in the example of FIG. 9, the searching may be carried out by including, in addition to the combination, a relationship type thereof as described with reference to FIG. 8.

Next, an example in which, in a case where the validity score is low, a combination similar to the combination of the subgraph that has not matched is searched from the common sense DB 32 to output it as a correction candidate will be described.

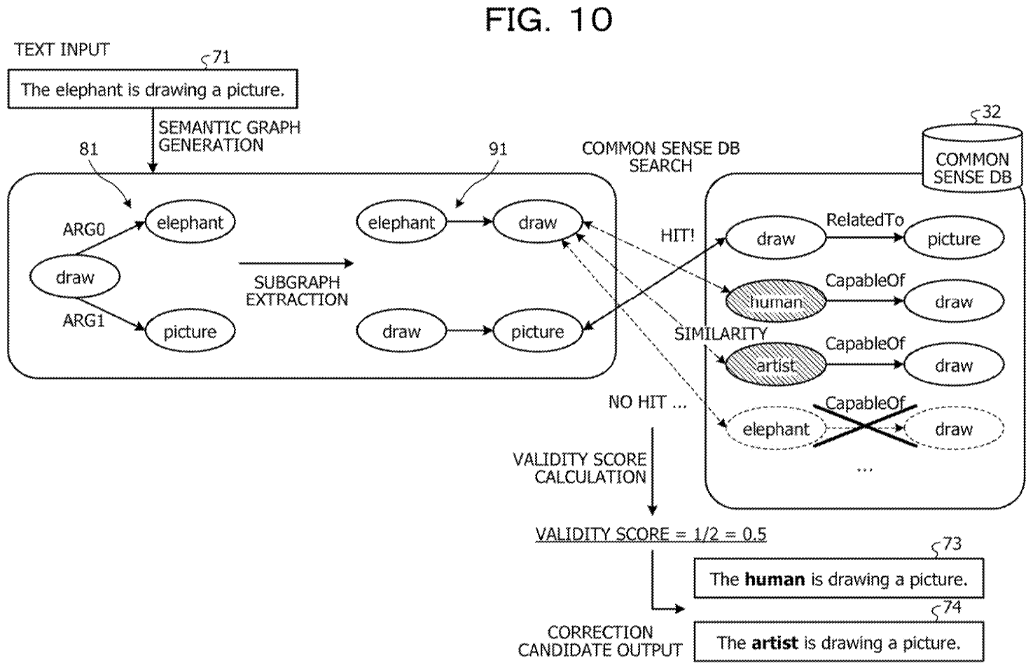

FIG. 10 is a diagram illustrating an exemplary correction candidate output process according to the first embodiment. The process up to the calculation process of the validity score in the example of FIG. 10 is the same as that in the example of FIG. 9. As illustrated in FIG. 10, in a case where the validity score is as low as 0.5, a combination similar to the combination of “elephant” and “draw” of the subgraph 91 that has not matched is searched from the common sense DB 32. Note that determination regarding similarity of the combination may be carried out not only by similarity determination of word spelling but also by similarity determination of meaning using the existing technique. Furthermore, determination regarding the level of the validity score may be carried out using any preset threshold value.

The example of FIG. 10 indicates that two combinations of “human” and “draw” and “artist” and “draw” are searched from the common sense DB 32 as similar combinations. When a similar combination is searched, the output device 10 corrects the original text data on the basis of the similar combination, and outputs it as a correction candidate. The example of FIG. 10 indicates that the part of “elephant” in the text data 71 is replaced with “human” or “artist” on the basis of the similar combination and individual text data 71 and 72 are output as correction candidates. Note that, in the searching for similar combinations for the correction candidate output as well, the common sense DB 32 may be searched including relationship types of combinations.

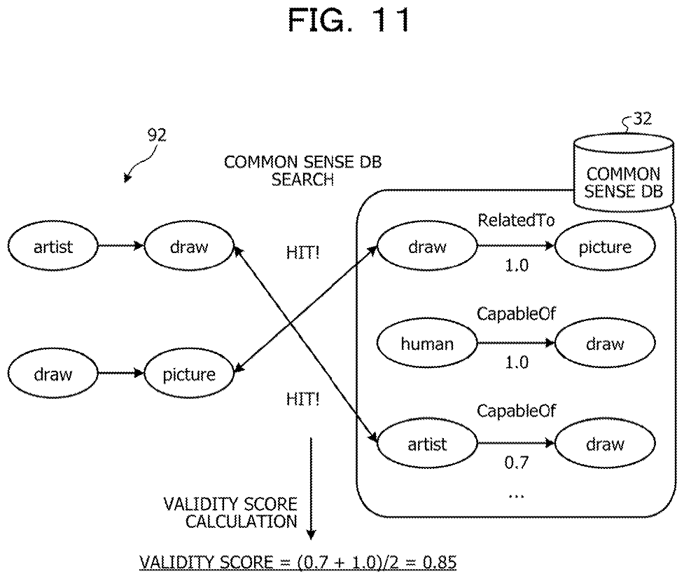

Furthermore, the validity score may be weighted and output. FIG. 11 is a diagram illustrating an exemplary weighted validity score output process according to the first embodiment. As illustrated in FIG. 11, for example, a weight between 0.7 and 1.0 may be given to a combination of a noun and a verb stored in the common sense DB 32 to calculate a validity score.

In the example of FIG. 11, both of two combinations of “artist” and “draw” and “draw” and “picture” included in the subgraph 92 match the data in the common sense DB 32, and weights of 0.7 and 1.0 are given to the combinations, respectively. Accordingly, the validity score is the sum of weights of matched combinations (0.7+1.0)/the total number of combinations 2=0.85.

The weight in the output process of the validity score may be regarded as strength and reliability of a combination of a noun and a verb. For example, in the example of FIG. 11, the weight for the combination of “draw” and “picture” is set to 1.0, and the weight for the combination of “artist” and “draw” is set to 0.7. The combination of “draw” and “picture” is appropriate as a sentence expression for picture drawing, and may be regarded as a highly reliable combination. On the other hand, the combination of “artist” and “draw” may not necessarily be regarded as a valid combination as some “artists”, such as a “musician” do not draw pictures, and thus it is weighted such that the validity becomes low.

[Process Flow]

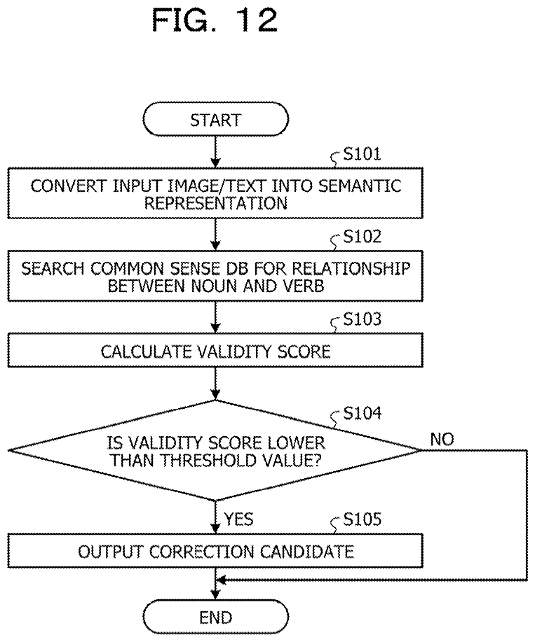

Next, a flow of the validity score output process performed by the output device 10 will be described with reference to FIG. 12. FIG. 12 is a flowchart illustrating an exemplary flow of the validity score output process according to the first embodiment. The validity score process illustrated in FIG. 12 may start with a situation where an image or text to be processed is, for example, uploaded to the output device 10 as a trigger, or may start at any timing.

First, the output device 10 obtains, from the input data 31, the input image or text to be processed, and converts it into a semantic representation (step S101).

Next, the output device 10 searches the common sense DB 32 for a relationship between a noun and a verb in the semantic representation converted in step S101 (step S102). For example, the output device 10 generates a semantic graph from the semantic representation converted in step S101 to extract a subgraph, and searches the common sense DB 32 for a combination of a noun and a verb in the subgraph. Note that, when searching the common sense DB 32, the searching may be carried out by including, in addition to the combination of the noun and the verb, a relationship type thereof.

Next, the output device 10 calculates a validity score on the basis of a result of the searching in the common sense DB 32 (step S103). For example, the output device 10 counts the number of matches of the combination of the noun and the verb in the searching in the common sense DB 32 in step S102, and outputs it as a validity score. Note that the validity score may be calculated while being weighted on the basis of a weight preset for each combination of a noun and a verb in the common sense DB 32, for example.

If the validity score output in step S103 is equal to or higher than a predetermined threshold value (No in step S104), it is determined that the combination of the noun and the verb in the semantic representation converted in step S101 is valid, and the validity score output process illustrated in FIG. 12 is terminated.

On the other hand, if the validity score output in step S103 is lower than the predetermined threshold value (Yes in step S104), the output device 10 determines that an inappropriate combination is included in the combinations of nouns and verbs in the semantic representation, and outputs a correction candidate (step S105). For example, the output device 10 searches the common sense DB 32 for a combination similar to the combination of the noun and the verb in the semantic representation that does not match the data in the common sense DB 32, and outputs it as a correction candidate. After the execution of step S105, the validity score output process illustrated in FIG. 12 is terminated.

[Effects]

As described above, the output device 10 analyzes the input image or text, converts it into a semantic representation, and outputs a validity score on the basis of the matching degree between the first relationship between the noun and the verb in the semantic representation and the second relationship between the noun and the verb in the common sense DB 32 stored in advance.

This makes it possible to determine the validity of the semantic representation in the input image or text without using the HV, which has disadvantages in terms of use such as difficulty in interpreting common sense, and difficulty in linking with the common sense DB. In this manner, the output device 10 may make it easier to use the common sense utilization technique in the machine learning.

Furthermore, the process of outputting the validity score executed by the output device 10 includes a process of counting the number of matches between the first relationship and the second relationship and outputting the number of matches as a validity score.

As a result, the output device 10 may make it easier to use the common sense utilization technique in the machine learning.

Furthermore, in a case where the validity score is lower than a predetermined threshold value, the output device 10 searches the common sense DB 32 for a second relationship similar to the first relationship that has not matched, and outputs it as a correction candidate.

As a result, the output device 10 is enabled to determine that an inappropriate combination is included in the combinations of nouns and verbs in the semantic representation of the input image or text to output a correction candidate.

Furthermore, the process of outputting the validity score executed by the output device 10 includes a process of outputting the validity score further on the basis of the weight preset in the second relationship that matches the first relationship.

As a result, the output device 10 is enabled to output a more appropriate validity score.

Furthermore, the process of outputting the validity score executed by the output device 10 includes a process of outputting the validity score further on the basis of the matching degree of the relationship type between the matching first relationship and second relationship.

As a result, the output device 10 is enabled to output a more appropriate validity score.

[System]

A processing procedure, a control procedure, a specific name, and information including various kinds of data and parameters indicated in the descriptions above or in the drawings may be changed in any ways unless otherwise specified. Furthermore, the specific examples, distributions, numerical values, and the like described in the embodiment are merely examples, and may be changed in any ways.

Furthermore, each component of each device illustrated in the drawings is functionally conceptual, and is not necessarily physically configured as illustrated in the drawings. For example, specific forms of distribution and integration of each device are not limited to those illustrated in the drawings. For example, all or a part thereof may be configured by being functionally or physically distributed or integrated in any units depending on various types of loads, usage situations, or the like. Moreover, all or any part of individual processing functions performed by each device may be implemented by a central processing unit (CPU), a graphics processing unit (GPU), and a program analyzed and executed by the CPU and the GPU, or may be implemented as hardware by wired logic.

[Hardware]

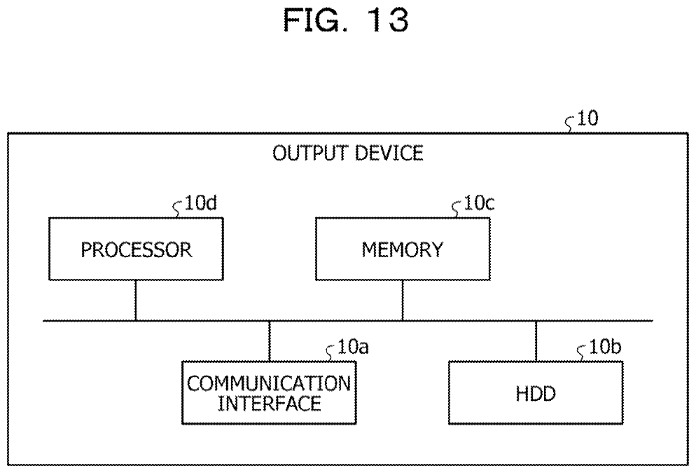

FIG. 13 is a diagram explaining an exemplary hardware configuration. As illustrated in FIG. 13, the output device 10 includes a communication interface 10a, a hard disk drive (HDD) 10b, a memory 10c, and a processor 10d. Furthermore, the individual units illustrated in FIG. 13 are mutually connected by a bus or the like.

The communication interface 10a is a network interface card or the like, and communicates with another server. The HDD 10b stores programs and DBs for operating the functions illustrated in FIG. 3.

The processor 10d is a hardware circuit that reads, from the HDD 10b or the like, a program that executes processing similar to that of each processing unit illustrated in FIG. 3 and loads it in the memory 10c to operate a process for implementing each function described with reference to FIG. 3 or the like. For example, this process implements a function similar to that of each processing unit included in the output device 10. For example, the processor 10d reads, from the HDD 10b or the like, a program having a function similar to that of the conversion unit 41, the output unit 42, or the like. Then, the processor 10d executes a process that executes processing similar to that of the conversion unit 41, the output unit 42, or the like.

In this manner, the output device 10 operates as an information processing apparatus that executes operation control processing by reading and executing the program that executes processing similar to that of each processing unit illustrated in FIG. 3. Furthermore, the output device 10 may also implement functions similar to those of the embodiment described above by, using a medium reading device, reading a program from a recording medium and executing the read program. Note that a program referred to in another embodiment is not limited to being executed by the output device 10. For example, the present embodiment may be similarly applied to a case where another computer or server executes the program, or a case where these cooperatively execute the program.

Furthermore, the program that executes processing similar to that of each processing unit illustrated in FIG. 3 may be distributed via a network such as the Internet. Furthermore, this program may be recorded in a computer-readable recording medium such as a hard disk, a flexible disk (FD), a compact disc read only memory (CD-ROM), a magneto-optical disk (MO), or a digital versatile disc (DVD), and may be executed by being read from the recording medium by a computer.

### Second Embodiment

While the embodiment has been described above, the embodiment may be implemented in various different modes in addition to the embodiment described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing an output program that causes at least one computer to execute a process, the process comprising:
converting input data into a semantic representation; and
outputting a validity score based on a matching degree between a first relationship between a noun and a verb in the semantic representation and a second relationship between the noun and the verb in a database.

2. The output program according to claim 1, wherein the outputting includes:
counting a number of matches between the first relationship and the second relationship; and
outputting the number of matches as the validity score.

3. The output program according to claim 1, wherein the process further comprising:
when the validity score is lower than a certain threshold value, searching the database for the second relationship analogous to the first relationship; and
outputting the second relationship as a correction candidate.

4. The output program according to claim 1, wherein
the outputting includes outputting the validity score based on a weight preset in the second relationship that matches the first relationship.

5. The output program according to claim 1, wherein
the outputting includes outputting the validity score based on a matching degree of a relationship type between the first relationship and the second relationship.

6. An output method for a computer to execute a process comprising:
converting input data into a semantic representation; and
outputting a validity score based on a matching degree between a first relationship between a noun and a verb in the semantic representation and a second relationship between the noun and the verb in a database.

7. The output method according to claim 6, wherein the outputting includes:
counting a number of matches between the first relationship and the second relationship; and
outputting the number of matches as the validity score.

8. The output method according to claim 6, wherein the process further comprising:
when the validity score is lower than a certain threshold value, searching the database for the second relationship analogous to the first relationship; and
outputting the second relationship as a correction candidate.

9. The output method according to claim 6, wherein
the outputting includes outputting the validity score based on a weight preset in the second relationship that matches the first relationship.

10. The output method according to claim 6, wherein
the outputting includes outputting the validity score based on a matching degree of a relationship type between the first relationship and the second relationship.

11. An output device comprising:
one or more memories; and
one or more processors coupled to the one or more memories and the one or more processors configured to:
convert input data into a semantic representation, and
output a validity score based on a matching degree between a first relationship between a noun and a verb in the semantic representation and a second relationship between the noun and the verb in a database.

12. The output device according to claim 11, wherein the one or more processors are further configured to:
count a number of matches between the first relationship and the second relationship, and
output the number of matches as the validity score.

13. The output device according to claim 11, wherein the one or more processors are further configured to:
when the validity score is lower than a certain threshold value, search the database for the second relationship analogous to the first relationship, and
output the second relationship as a correction candidate.

14. The output device according to claim 11, wherein the one or more processors are further configured to
output the validity score based on a weight preset in the second relationship that matches the first relationship.

15. The output device according to claim 11, wherein the one or more processors are further configured to
output the validity score based on a matching degree of a relationship type between the first relationship and the second relationship.
